(19) United States
(12) Patent Application Publication
(10) Pub. No.: US 2005/0114185 A1
(43) Pub. Date: May 26, 2005

(54) Method and apparatus for restaurant ordering and reservations

(75) Inventors: Herman Rodriguez, Austin, TX (US); Newton James Smith, Austin, TX (US); Clifford Jay Spinac, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/718,065

(22) Filed: Nov. 20, 2003

(51) Int. Cl. G06F 17/60

(52) U.S. Cl. 705/5

(57) ABSTRACT

A method, apparatus, and computer instructions for making reservations or placing orders. A wireless hot spot location is provided in which reservations can be made with a plurality of vendors through the wireless hot spot. A determination is made as to whether a user desires to make a reservation with a selected one of the plurality of vendors in response to receiving a user input from a wireless device in communication with the wireless hot spot. User preferences associated with the user is retrieved in response to a determination that the user desires to make the reservation. The reservation is made using the user preferences.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for making restaurant reservations and ordering.

2. Description of Related Art

In today's times, most people eat out at restaurants on a regular basis. In fact, many people go out to eat one or more times each week. When going to popular restaurants, a customer most often waits in line for a table. This wait may vary from a few minutes to a few hours depending on the popularity of the restaurant. Many restaurants allow customers to make reservations and even pre-order food to avoid wait times.

Making reservations and ordering food generally requires a telephone call. This process is a manual one, requiring the customer to talk to a reservationist or other person at the restaurant to make the arrangements. Often times, a customer would like to tell the person on the telephone at the restaurant that they want their usual table or order when they have been to that particular restaurant a numbers of times. This situation occurs because the usual person that they talk to may not be the one to answer the phone or may not be available. The customer must then go into detail with the person making the arrangements at the restaurant their preferences for tables or ordering. Further, in some cases, the customer may be placed on hold. Other times, the personnel at the restaurant may be unable to answer the phone and the customer receives a recorded message. These types of situations are frustrating and take time for a user wishing to make reservations. It would be advantageous to have an improved method, apparatus, and computer instructions for making reservation arrangements.

### SUMMARY OF THE INVENTION

The present invention provides a method, apparatus, and computer instructions for making reservations or placing orders. A wireless hot spot location is provided in which reservations can be made with a plurality of vendors through the wireless hot spot. A determination is made as to whether a user desires to make a reservation with a selected one of the plurality of vendors in response to receiving a user input from a wireless device in communication with the wireless hot spot. User preferences associated with the user is retrieved in response to a determination that the user desires to make the reservation. The reservation is made using the user preferences.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a network data processing system in which the present invention is implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram of a wireless device in the form of a personal digital assistant (PDA) in accordance with a preferred embodiment of the present invention;

FIG. 5 is a diagram illustrating components used in making reservations through wireless hot spot locations in accordance with a preferred embodiment of the present invention;

FIG. 6 is a flowchart of a process for making a reservation in accordance with a preferred embodiment of the present invention;

FIG. 7 is a flowchart of a process for making a reservation in accordance with a preferred embodiment of the present invention;

FIG. 8 is a flowchart of a process for generating a reservation in accordance with a preferred embodiment of the present invention; and

FIG. 9 is a flowchart of a process for making a reservation for user by vendor in accordance with a preferred embodiment of the present invention.

### DETAILED DESCRIPTION OF THE PREFERRED EMBODIMENT

With reference now to the figures and in particular with reference to FIG. 1, a network data processing system is depicted in which the present invention is implemented. Network data processing system 100 includes network 102, which is the medium used to provide communications links between various devices and computers connected together within network data processing system 100. Network 102 may include connections, such as wire, wireless communications links, or fiber optic cable.

In the depicted example, server 104 is connected to network 102. In addition, clients 106 and 108 are connected to network 102. These clients may be, for example, personal computers or network computers. Further, clients 110 and 112 are connected to network 102. In the illustrative example, these two clients are connected through wireless communications links and are wireless devices. In particular, clients 110 and 112 are personal digital assistants (PDA). Server 104 in this example may provide data, such as boot files, operating system images, applications, web pages, and other information to clients 106 and 108. Network data processing system 100 may include additional servers, clients, and other devices not shown. For example, other devices may include routers, switches, or wireless access points to provide for the routing and transmission of data within network 102.

In the depicted example, network data processing system 100 is the Internet with network 102 representing a world wide collection of networks and gateways that use the transmission control protocol/internet protocol (TCP/IP) suite of protocols to communication with one another. of course, network data processing system 100 also may be implemented as a number of different types of networks, such as, for example, an intranet, a local area network (LAN), or a wide area network (WAN). Network data processing system 100 in FIG. 1 is intended as an illustrative embodiment and not as an architectural limitation for the present invention.

Within network 102, hot spots may be provided through various wireless access points to generate hot spot locations. In this manner, clients 110 and 112 may access network 102 when within a hot spot location. In these examples, a hot spot location is a location in which a wireless device is in proximity to a wireless access point such that communication or exchange of data may be made with that wireless access point. The present invention in the illustrative embodiments allow for reservations to be generated through wireless devices, such as clients 110 and 112 when these clients are within selected hot spot locations. These reservations may be made through communications where the server, such as server 104, or through clients 106 and 108, when these devices are used by businesses to obtain information for generating reservations using the mechanism of the present invention and the illustrative embodiments.

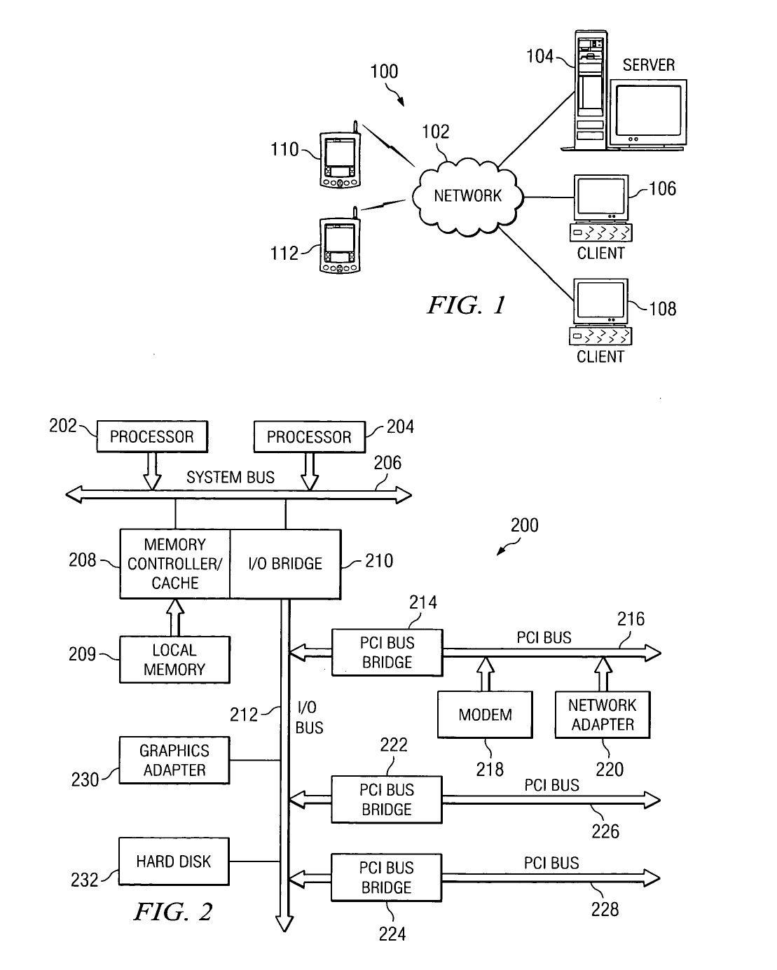

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory. controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 106-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, New York, running the Advanced Interactive Executive (AIX) operating system or Linux operating system.

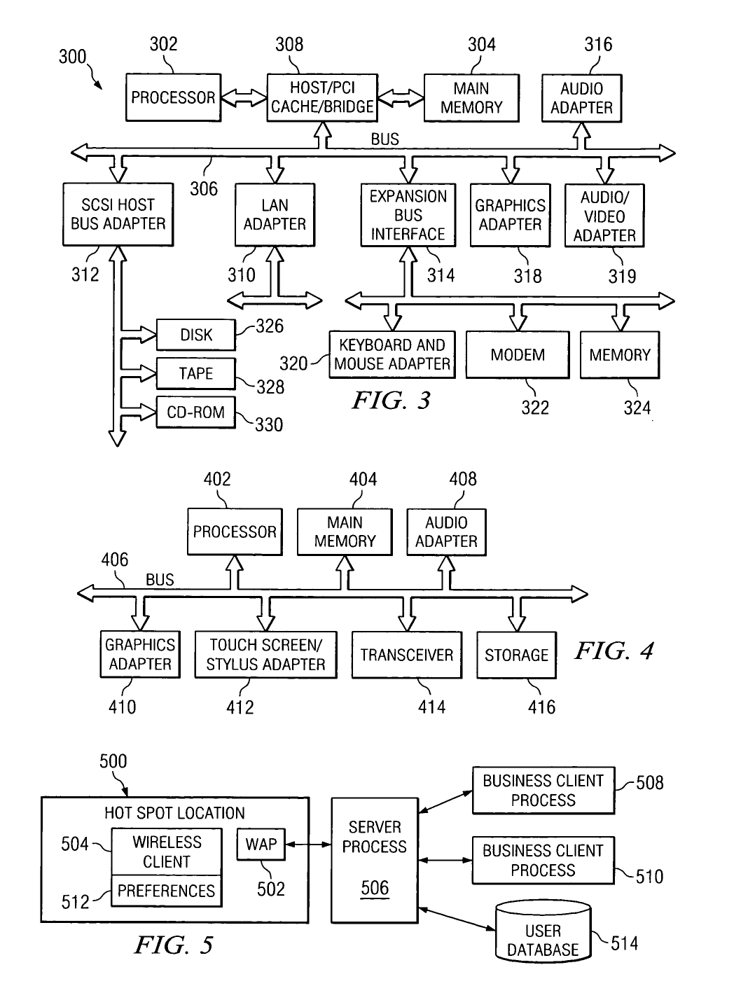

With reference now to FIG. 3, a block diagram illustrating a data processing system is depicted in which the present invention may be implemented. Data processing system 300 is an example of a client computer, such as client 106 or client 108 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. Instructions for the operating system and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or scanner, and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning now to FIG. 4, a diagram of a wireless device in the form of a personal digital assistant (PDA) is shown in accordance with a preferred embodiment of the present invention. PDA 400 is an example of a PDA, such as wireless client 110 or wireless client 112 in FIG. 1. PDA 400 includes processor 402 and main memory 404 connected to bus system 406. Further, PDA 400 also includes audio adapter 408, graphics adapter 410, touch screen/stylus adapter 412, transceiver 414, and storage 416 connected to system bus 406.

Audio adapter 408 and graphics adapter 410 provide an interface for the user to hear and see information. Touch screen/stylus adapter 414 allows the user to interact with PDA 400. This particular component allows the user to use a stylus to input data into a touch screen display on PDA 400.

Processor 402 executes instructions stored in main memory 404 to provide the process and function of the present invention. Storage 416 provides for additional storage of data and applications. Storage 416 may take various forms, such as, for example, a flash memory. This flash memory in the illustrative embodiments may be, for example, a memory stick, a secured digital (SD) card, a CompactFlash card, or SmartMedia card. Transceiver 414 provides for sending and receiving data through a wireless communications link.

An operating system runs on processor 402 and is used to coordinate and provide for control of various components within PDA 400 and FIG. 4. The operating system may be, for example, a commercially available operating system, such as Windows Mobile, which is available from Microsoft Corporation. Instructions for the operating system and applications or programs are located on storage 416 in these examples. These instructions may be loaded into main memory 404 for execution by processor 402.

Those of ordinary skill in the art will appreciate that the hardware in FIG. 4 may vary depending on the implementation. Other internal hardware or peripheral devices, such as additional storage in the form of flash read only memory (ROM) or equivalent non-volatile memory may be used in addition or in place of the hardware illustrated in FIG. 4.

Turning next to FIG. 5, a diagram illustrating components used in making reservations through wireless hot spot locations is depicted in accordance with the preferred embodiment of the present invention. In this example, hot spot location 500 is provided through wireless access point (WAP) 502. Wireless client 504 is said to be within hot spot location 500 when client 504 is able to establish a communications link with wireless access point 502, which forms the hot spot in these examples. In this manner, wireless client 504 is able to exchange data with server process 506. Server process 506 may be located on data processing system, such as data processing system 200 in FIG. 2.

The present invention provides a method, apparatus, and computer instructions for making reservations with a vendor. In these illustrative embodiments, the vendor takes the form of a restaurant. Of course, other vendors such as a bowling alley, reservation service, or a movie theater may be provided as vendors. The mechanism of the present invention provides for one or more hot spot locations in which the user may contact a vendor to make a reservation. With restaurants, the user also may send food orders in from the hot spot location without having to call and verbally communicate with the vendor or actually enter the active premises of the vendor.

In this manner, users may generally make reservations and send in orders without having to call the vendor or the active premises of the vendor. Wireless client 504 may contact only selected vendors in hot spot location 500. Reservations for these selected vendors may be sent to business client processes 508 and 510 by server process 506. These client processes may be located on a data processing system, such as data processing system 300 in FIG. 3. These client processes may be located at different vendors in these illustrative embodiments.

In particular, a user entering hot spot location 500 with wireless client 504 may receive a list of available vendors. This list may be presented using a browser and hypertext markup language (HTML) or web pages presented on wireless client 504. This list may originate from server process 506 in these examples. Further, when in hot spot location 500, the user may be unable to contact other vendors than those set up through server process 506.

In this manner, different vendors may purchase “listings” for different hot spot locations. A reservation request may be made with one of the vendors by selecting that vendor from the list at wireless client 504. This selection is sent back to server process 506, which sends the reservation information to business client process 508 or business client process 510 depending on the vendor selected by the user. In this manner, a reservation may be made between a user and a vendor from hot spot location 500.

The reservation request generated by wireless client 504 may include various user preferences. These preferences may be obtained from preferences 512 located within wireless client 504. User preferences are the selections made by a user for various vendor items or services. In many cases, these user preferences may be habitual selections that may be normally made or requested for a particular vendor. These user preferences may include, for example, the date for the reservation, the time for the reservation, the number of persons, a preferred table location, and even one or more orders. When this request is received at a business client process, such as business client process 508, the request is processed to determine whether the different preferences of the user can be met. If all of the preferences are met, then a confirmation is returned to wireless client 504. If not all the preferences can be met, then reservation details are returned to wireless client 504.

For example, if the time requested by the user cannot be met, an alternative time may be presented to the user in these reservation details. When the user receives reservation details at wireless client 504, the user may choose to accept the reservation and at that time, the acceptance is sent back to business client process 508. In response, a confirmation of the reservation is returned to wireless client 504. If the user does not accept these details, a cancellation message is returned to business client process 508. At that time, the user wireless client 504 may choose to make another reservation with slightly different preferences or select a different vendor from the list.

Further, the different user preferences may be stored remotely from wireless client 504 depending on the particular embodiment. For example, user preferences may be stored within user database 514 in the data processing system at which server process 506 executes. In this manner, the user is able to make reservations and even generate orders without having to call the vendor directly.

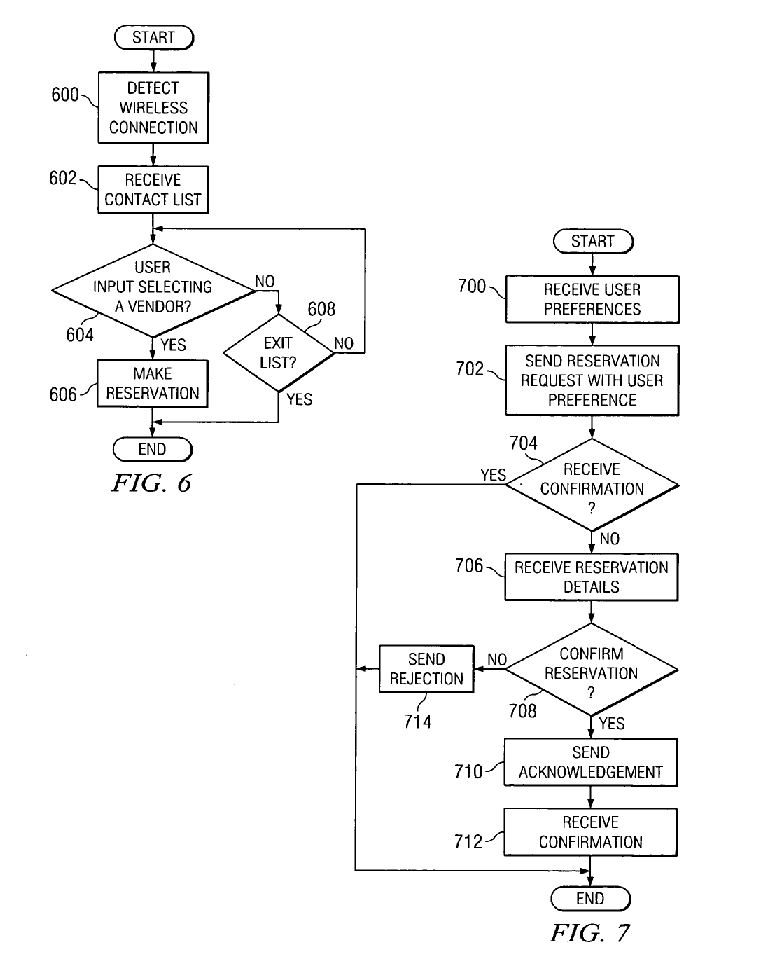

Turning now to FIG. 6, a flowchart of a process for making a reservation is depicted in accordance with the preferred embodiment of the present invention. The process illustrative in FIG. 6 may be implemented in a wireless client such as wireless client 504 in FIG. 5.

The process begins by detecting a wireless connection (step 600). The wireless connection occurs when the wireless device is within proximity of a hot spot such that a communications link may be established with the hot spot.

Thereafter, a contact list is received (step 602). This contact list in these examples is a list of vendors that is provided through a server process, such as server process 506 in FIG. 5. Next, a determination is made as to whether a user input selecting a vendor has been received (step 604). If a user input selecting a vendor has been received, the reservation is then made (step 606) with the process terminating thereafter. Otherwise, a determination is made as to whether the user input is to exit the listing (step 608). In step 608 the user may move out of the hotspot causing an exit from the list. If the user input exits the listing, the process terminates. Otherwise, the process returns to step 604, where the process continues until the user selects a vendor or until the user moves out of range of the hotspot.

Turning next to FIG. 7, a flowchart of a process for making a reservation is depicted in accordance with a preferred embodiment of the present invention. The process illustrated in FIG. 7 may be implemented in a wireless client, such as wireless client 504 in FIG. 5 this flowchart is a more detailed description of (step 606) in FIG. 6.

The process begins by retrieving user preferences (step 700). This step may involve retrieving the user preferences locally from within the wireless client or those preferences may be retrieved from a remote location, such as user database 514 in FIG. 5. Then, a reservation request is sent with the preferences to the vendor selected by the user (step 702). Thereafter, a determination is made as to whether a confirmation for the reservation has been received (step 704). If a confirmation has been received, the process terminates. In this instance, all of the user preferences are available at the vendor.

Otherwise, reservation details are received from the vendor (step 706). These details include information, such as, for example, the date and time of the reservation, the number of persons for the reservation, a smoking preference, and orders that may be filled. When reservation details are received without a confirmation from the vendor, one or more preferences cannot be met by the vendor. For example, if the user requests a table for 4 at 7:00 p.m. the reservation details may be for a table for 4 at 7:15 p.m. At that time, a determination is made as to whether the reservation is to be confirmed (step 708).

If the user decides to accept the reservation details, then an acknowledgement is sent (step 710). Thereafter, a confirmation of these reservation details is received (step 712) with a process terminating thereafter. This confirmation may include information, such as information to update a calendar and a to-do list with the reservation. Further, this information may include an update for the user's address book with the phone number and address of the restaurant.

With reference again to (step 708), if the user does not confirm the reservation, a rejection of the reservation details is returned to the vendor (step 714) with the process terminating thereafter. At this time, the user may select another vendor or resend a different request with different preferences depending on the user's wishes.

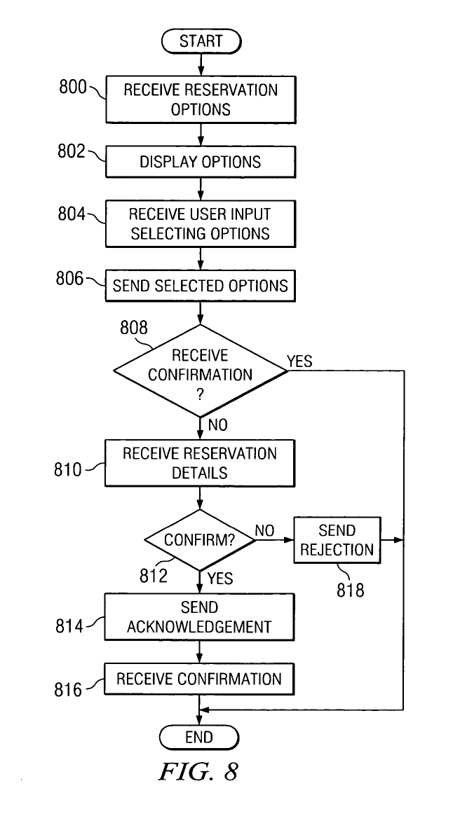

With reference next to FIG. 8, a flowchart of a process for generating a reservation is depicted in accordance with the preferred embodiment of the present invention. The process illustrated in FIG. 8 may be implemented in a wireless client, such as wireless client 504 in FIG. 5. The process illustrated in FIG. 8 is an alternative embodiment to the process illustrated in FIG. 7. This process allows a user to select options while making a reservation request.

The process begins by receiving reservation options (step 800). These options are displayed to the user (step 802). Then user input is received selecting options (step 804). These options may include, for example, seating availability for certain times, orders that may be pre-sent, and smoking preferences that are available. Selected options are then sent to the vendor in response to receiving user input selecting options (step 806).

A determination is then made as to whether a confirmation is received for the reservation (step 808). If a reservation confirmation is not received, then reservation details are received. In this instance, some of the options selected by the user may no longer be available. In that case, a determination is made as to whether the user confirms the reservation based on the details received (step 812). If the reservation based on the details received is confirmed, then an acknowledgement is sent to the vendor (step 814). Then, a confirmation of the reservation is received from the vendor (step 816) with the process terminating thereafter.

With reference again to step 812, if a confirmation is not made, then a rejection is sent to the vendor (step 818) with the process terminating thereafter. In this case, the user may reselect options or select a different vendor. With reference again to (step 808), if a confirmation is received from the options sent to the vendor, the process terminates with the reservation being made for the user.

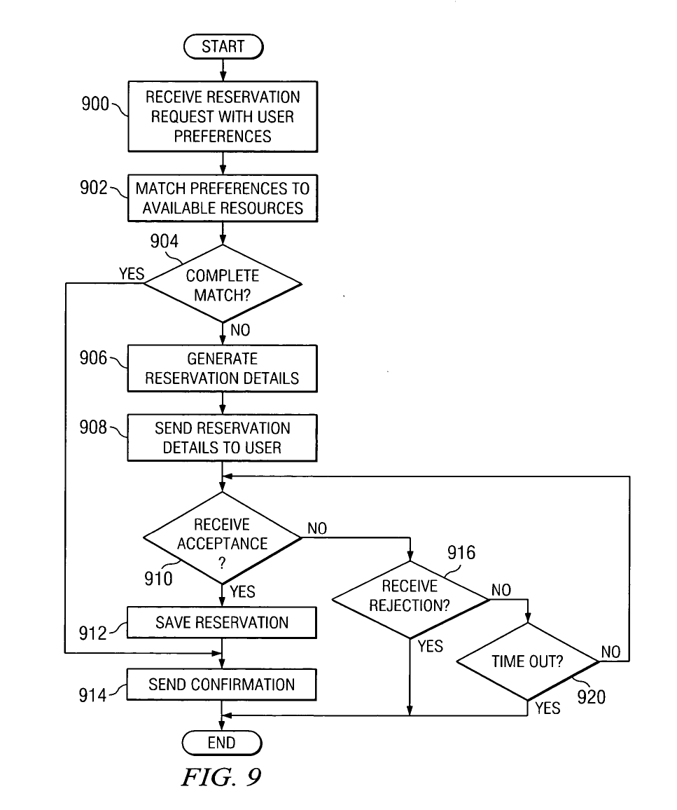

Turning next to FIG. 9, a flowchart of a process for making a reservation for a user by a vendor is depicted in accordance with a preferred embodiment of the present invention. The steps illustrated in FIG. 9 may be implemented in a business client process, such as business client process 508 in FIG. 5.

The process begins by receiving a reservation request with user preferences (step 900). Thereafter, the preferences are matched with availability of resources at the vendor (step 902). These resources include, for example, availability of seating at different times, availability of particular tables at particular locations, whether particular orders can be filled at the time the reservation is requested, and whether a particular wait person may be available. A determination is whether a complete match for all preferences is made (step 904). If a complete match between resource availability and user preferences does not occur, then reservation details are generated (step 906). In generating reservation details, alternative resources may be presented in these details. For example, if a particular time requested by user, such as 7:00 p.m. cannot be met, reservation details may be generated with an alternative time, such as 7:15. These reservation details are then sent back to the user at the wireless client (step 908).

A determination is then made as to whether an acceptance of the reservation details has been received (step 910). If an acceptance is received, the reservation is saved (step 912), and a confirmation of the reservation is returned to the user (step 914) with the process terminating thereafter.

With reference again to (step 910), if an acceptance has not been received, a determination is made as to whether a rejection of the reservation has been received (step 916). If a rejection has not been received, a determination is made as to whether a time out has occurred (step 920). If a time out has not occurred, the process returns (step 910). If a time out has occured in step 920 or a rejection has been received in step 916, the process terminates. With reference again to step 904, if a complete match does occur, the process proceeds to step 914 to send the confirmation with the process terminating thereafter.

Thus, the present invention provides an improved method, apparatus, and computer instructions for making reservations with one or more vendors. The mechanism of the present invention allows for users to make reservations without having to call a vendor or visit the vendor location. The illustrative embodiments provide a hot spot location in which a user with a wireless device may receive a selection of vendors. In the illustrative embodiments, the vendors are a list of restaurants. A user may select one of the restaurants to generate a request. User preferences may be sent along with the request, such as an order, a smoking preference, or even a table location. A confirmation of the reservation may be made or reservation details may be received in which some of the preferences may not have been matched. In that case, the reservation details may propose an alternative option that the user may accept or reject.

Of course, the vendors may include other businesses or organizations other than restaurants. For example, a vendor also may be a hotel, a movie theater, a sports park, or a reservation service that may make reservations for a user with different businesses or vendors.

These hot spot locations may be placed in different areas, such as buildings lobbies, airports, banks, at ATM machines, in taxis, or even in grocery stores. For businesses that are visited regularly by user, preferences may even include orders that may be selected and placed in advance. In this manner, if the user is in a hurry or the particular order requires advance preparation, then these orders may be made and ready at the time of the user's reservation.

Further, these hot spot locations may be set up by a business or other organization, which charges the vendors listed for making reservations. In this case, the vendors may be charged per reservation or on some periodic basis. Alternatively, the customers or users in the hotspot could be charged or both the vendors and the customer or users may be charged. These hot spots may be used as an incentive to get users to come to a hot spot location. For example, a hot spot location may be set up for a shopping center in which users may use the hot spot location for free to make reservations. Further, in the implementations in which access in a hot spot location is only provided for free with respect to making reservations with vendors, free Internet access may be provided after a reservation has been made to encourage use of the hot spot location.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of encoded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for making reservations, the method comprising:
providing a wireless hot spot location, wherein reservations can be made with a plurality of vendors through the wireless hot spot;
responsive to receiving a user input from a wireless device in communication with the wireless hot spot, determining whether a user desires to make a reservation with a selected vendor from the plurality of vendors;
responsive to a determination that the user desires to make the reservation, retrieving user preferences associated with the user; and
making the reservation using the user preferences.

2. The method of claim 1, wherein the user preferences are located in the wireless device.

3. The method of claim 1, wherein the user preferences are located in a data processing system.

4. The method of claim 1, wherein the wireless device is one of a personal digital assistant, a laptop computer, a hand held computer, notebook computer, or a digital wireless phone.

5. The method of claim 1, wherein the user preferences also are associated with the selected one of the plurality of vendors.

6. The method of claim 1, wherein the plurality of vendors are a set of registered vendors.

7. The method of claim 6, wherein the user preferences include at least one of a desired location for a table, credit card information, a smoking preference, time, number of seats needed, a particular wait person, and ordering information.

8. The method of claim 1, wherein the plurality of vendors includes at least one of a restaurant, a hotel, a movie theater, and a reservation service.

9. The method of claim 1, further comprising charging at least one of the selected vendor and the user.

10. The method of claim 1 further comprising:
providing Internet access after making the reservation.

11. A method in a wireless data processing system for making reservations, the method comprising:
receiving an identification of a plurality of vendors while the wireless data processing system is in a hot spot location; and
responsive to receiving a user input from a user indicating a desire to make a reservation with a selected vendor from the plurality of vendors, sending user preferences of the user to the selected vendor.

12. A data processing system for making reservations, the data processing system comprising:
a bus system;
a communications unit connected to the bus system;
a memory connected to the bus system, wherein the memory includes a set of instructions; and
a processing unit connected to the bus system, wherein the processing unit executes the set of instructions to determine whether a user desires to make a reservation with a selected one of a plurality of vendors in response to receiving a user input from a wireless device in communication with a wireless hot spot; retrieve user preferences associated with the user in response to a determination that the user desires to make the reservation; and make the reservation using the user preferences.

13. A data processing system for making reservations, the data processing system comprising:
providing means for providing a wireless hot spot location, wherein reservations can be made with a plurality of vendors through the wireless hot spot;
determining means, responsive to receiving a user input from a wireless device in communication with the wireless hot spot, for determining whether a user desires to make a reservation with a selected one of the plurality of vendors;
retrieving means, responsive to a determination that the user desires to make the reservation, for retrieving user preferences associated with the user; and
making means for making the reservation using the user preferences.

14. The data processing system of claim 13, wherein the user preferences are located in the wireless device.

15. The data processing system of claim 13, wherein the user preferences are located in a data processing system.

16. The data processing system of claim 13, wherein the wireless device is one of a personal digital assistant, a laptop computer, or a digital wireless phone.

17. The data processing system of claim 13, wherein the user preferences also are associated with the selected one of the plurality of vendors.

18. The data processing system of claim 13, wherein the plurality of vendors are a set of registered vendors.

19. The data processing system of claim 18, wherein the user preferences include at least one of a desired location for a table, credit card information, a smoking preference, time, number of seats needed, and ordering information.

20. The data processing system of claim 13, wherein the plurality of vendors includes at least one of a restaurant, a hotel, and a movie theater.

21. A computer program product in a computer readable medium for making reservations, the computer program product comprising:
second instructions, responsive to receiving a user input from a wireless device in communication with a wireless hot spot, for determining whether a user desires to make a reservation with a selected one of a plurality of vendors;
third instructions, responsive to a determination that the user desires to make the reservation, for retrieving a user preferences associated with the user; and
fourth instructions for making the reservation using the user preferences.

22. The computer program product of claim 21, wherein the user preferences are located in the wireless device.

23. The computer program product of claim 21, wherein the user preferences are located in a data processing system.

24. The computer program product of claim 21, wherein the wireless device is one of a personal digital assistant, a laptop computer, or a digital wireless phone.

25. The computer program product of claim 21, wherein the user preferences also are associated with the selected one of the plurality of vendors.

26. The computer program product of claim 21, wherein the plurality of vendors are a set of registered vendors.

27. The computer program product of claim 26, wherein the user preferences include at least one of a desired location for a table, credit card information, a smoking preference, time, number of seats needed, and ordering information.

28. The computer program product of claim 21, wherein the plurality of vendors includes at least one of a restaurant, a hotel, and a movie theater.
